(19) United States
(12) Patent Application Publication
(10) Pub. No.: US 2004/0163445 A1
(43) Pub. Date: Aug. 26, 2004

(54) Apparatus and process for sensing fluoro species in semiconductor processing systems

(76) Inventors: Frank Dimeo JR., Danbury, CT (US); Philip S.H. Chen, Bethel, CT (US); Ing-Shin Chen, Danbury, CT (US); Jeffrey W. Neuner, Bethel, CT (US); James Welch, Fairfield, CT (US)

Correspondence Address: ATMI, INC., 7 COMMERCE DRIVE, DANBURY, CT, 06810, US

(21) Appl. No.: 10/784,750

(22) Filed: Feb. 23, 2004

Related U.S. Application Data
(63) Continuation-in-part of application No. 10/273,036, filed on Oct. 17, 2002.

(51) Int. Cl. G01N 7/00

(52) U.S. Cl. 73/23.2

(57) ABSTRACT

A gas detector and process for detecting a fluorine-containing species in a gas containing same, e.g., an effluent of a semiconductor processing tool undergoing etch cleaning with HF, NF₃, etc. The gas detector preferably employs a nickel-containing filament that is sensitive to the fluorine-containing species, which can function both as a sensing component and as a heat source when elevated temperature sensing is required. Such nickel-containing filament can be constructed with various compositions and configurations to improve its signal strength and responsiveness, and is particularly suitable for fluoro sensing operations at constant resistance (CR) mode.

### CROSS-REFERENCE TO RELATED APPLICATIONS

This is a continuation-in-part of U.S. patent application Ser. No. 10/273,036 filed Oct. 17, 2002 for “APPARATUS AND PROCESS FOR SENSING FLUORO SPECIES IN SEMICONDUCTOR PROCESSING SYSTEMS” in the names of Frank Dimeo Jr., Philip S. H. Chen, Jeffrey W. Neuner, James Welch, Michele Stawasz, Thomas H. Baum, Mackenzie E. King, Ing-Shin Chen, and Jeffrey F. Roeder.

### GOVERNMENT RIGHTS IN INVENTION

Work related to the invention hereof was conducted in the performance of NIST ATP Program, Contract Number 70NANB9H3018 for “Integrated MEMS Reactor Gas Monitor Using Novel Thin Film Chemistry for the Closed Loop Process Control and Optimization of Plasma Etch and Clean Reactions in the Manufacturing of Microelectronics.” The Government has certain rights in the invention.

### BACKGROUND OF THE INVENTION

1. Field of the Invention

The present invention relates generally to a device and a method for sensing fluoro species, which have utility for monitoring of fluorine-containing compounds and ionic species in semiconductor process operations.

2. Description of the Related Art

In the manufacture of semiconductor devices, the deposition of silicon (Si) and silicon dioxide (SiO₂), and subsequent etching, are vital operational steps that currently comprise 8-10 steps or roughly 25% of the total manufacturing process. Each deposition tool and etch tool must undergo a periodic cleaning procedure, sometimes as often as every run, in order to ensure uniform and consistent film properties.

Currently, in etching operations, etch endpoints are reached when a prescribed amount of time has elapsed. Over etch, in which the process gas continues to flow into the reactor chamber after the cleaning etch is finished, is common and leads to longer process cycles, reduced tool lifetimes, and unnecessary global-warming-gas losses to the atmosphere (Anderson, B.; Behnke, J.; Berman, M.; Kobeissi, H.; Huling, B.; Langan, J.; Lynn, S-Y., Semiconductor International, October (1993)).

Similar issues are present in the etching of silicon nitride materials when SiN is utilized in semiconductor device structures.

Various analytical techniques, such as FTIR, Optical Emission Spectroscopy, and Ionized Mass Spectroscopy, can be used to monitor the etch process. However, these techniques tend to be expensive, and often require a dedicated operator due to their complexity.

It would therefore be a significant advance in the art to provide a reliable, low-cost gas-sensing capability that will serve to improve the throughput and chemical efficiency of the equipment used for the deposition and etching of silicon-containing materials, including silicon, silicon nitride and silicon dioxide, by reducing and optimizing clean and etch times, and hence reducing chemical usage, lengthening equipment operating life, and decreasing equipment down time.

U.S. patent application Ser. No. 10/273,036 filed Oct. 17, 2002 for “APPARATUS AND PROCESS FOR SENSING FLUORO SPECIES 1N SEMICONDUCTOR PROCESSING SYSTEMS” discloses an apparatus and method for sensing solid-state fluoro species, using a fluoro-reactive metal filament weaved around metal packaging posts or Vespel® polyimide blocks on a KF flange. Detection of the fluoro species using such metal filament-based sensors relies on monitoring the resistance changes in the metal filaments caused by their reactions with the fluorine-containing compounds. In order to ensure acceptable sensitivity and signal-to-noise ratio for such metal filament-based sensors, the dimensions and the positions of the metal filaments are controlled and optimized via uses of the metal packaging posts or the Vespel® polyimide blocks, to provide an absolute resistance that is adequate for endpoint detection.

There is a continuing need to discover and develop improved filament-based sensors, by employing new compositions and structures to further enhance the sensitivity, signal-to-noise ratio, and mechanical reliability of such gas sensors, as well as to further reduce the response time and the manufacturing costs thereof.

### SUMMARY OF THE INVENTION

The present invention relates generally to apparatus and method for sensing fluoro species in an environment susceptible to the presence of such species, such as an ambient environment, a gaseous effluent stream from a semiconductor manufacturing process, etc.

In one aspect, the invention relates to a gas sensor assembly comprising a gas-sensing filament comprising nickel or nickel alloy.

Another aspect of the invention relates to a gas sensor assembly comprising a gas-sensing filament comprising a coating structure encapsulating a core structure, wherein such coating structure comprises nickel or nickel alloy, wherein such core structure is characterized by an electrical resistivity that is higher than that of the coating structure and a heat capacity that is lower than that of the coating structure.

Preferably, such core structure is characterized by an electrical resistivity that is at least fifty (50) times larger than that of the coating structure, and a heat capacity that is less than three fourth (¾) of that of the coating structure. More preferably, such core structure is characterized by an electrical resistivity that is at least one thousand (1000) times larger than that of the coating structure, and a heat capacity that is less than one half (½) of that of the coating structure. Most preferably, such core structure is characterized by an electrical resistivity that is at least 10 mΩ·cm and a heat capacity that is less than 2.5 J/K·cm³. In a particularly preferred embodiment of the invention, the core structure comprises silicon carbide. In another preferred embodiment of the invention, the core structure further comprises a composite structure formed by coating a carbon core fiber with silicon carbide.

Yet another aspect of the invention relates to a gas sensor assembly comprising a gas-sensing filament comprising nickel or nickel alloy, wherein such gas-sensing filament is fabricated by electrochemical thinning techniques and is therefore characterized by an average diameter of not more than 50 microns, preferably not more than 25 microns, more preferably not more than 10 μm, and most preferably within a range of from about 0.1 μm to about 5 μm.

The invention in a corresponding aspect relates to a method for fabricating a gas sensor assembly comprising a nickel-containing gas-sensing filament that is characterized by an average diameter of not more than 50 microns, comprising the step of: (1) providing a gas sensor assembly comprising a nickel-containing gas-sensing filament having an average diameter that is more than 50 microns; and (2) electrically thinning such nickel-containing gas-sensing filament for a sufficient period of time so as to reduce the average diameter of such nickel-containing gas-sensing filament to 50 microns or less.

A further aspect of the present invention relates to a gas sensor assembly comprising a gas-sensing filament comprising nickel-copper alloy. Preferably, such nickel-copper alloy contains from about 10% to 90% nickel by weight, and from about 10% to about 90% copper by weight. More preferably, such nickel-copper alloy further comprises aluminum in the amount of from about 10% to about 90% by weight. Such nickel-copper alloy may also comprise other fluoro-resistant metal components, including but not limited to Ti, V, Cr, Mn, Nb, Mo, Ru, Pd, Ag, Ir, and Pt.

A still further aspect of the present invention relates to a gas sensor assembly comprising a nickel-containing gas-sensing filament having a porous surface having about 20% to about 80% total porosity, and more preferably 60% total porosity. Preferably, such porous surface of such gas-sensing filament is characterized by open pore structures.

Another aspect of the invention relates to a gas sensor assembly as described hereinabove, which further comprises means coupled with the gas-sensing filament for detecting a change in at least one property of such gas-sensing filament upon contact with a target gas species and responsively generating an output signal indicative of the presence of such target species.

Another aspect of the invention relates to a gas sensor assembly comprising an above-described gas-sensing filament and a support structure, wherein the gas-sensing filament is mounted on such support structure in a free-standing manner.

Yet another aspect of the present invention relates to a gas sensor assembly as described hereinabove, arranged in sensing relationship to a process chamber that is susceptible to presence of one or more target fluoro species, wherein the gas-sensing filament is mounted on a fluoro-resistant support structure and coupled to means for detecting a change in at least one property of such gas-sensing filament upon contact with the target fluoro species and responsively generating an output signal indicative of the presence of said target fluoro species.

The invention in a further aspect relates to a gas sensor assembly as described hereinabove, which is constructed and arranged to monitor an effluent from a semiconductor manufacturing plant or a fluid derived from the effluent, wherein the effluent or fluid derived therefrom is susceptible of comprising a fluoro species, and wherein such gas sensor assembly further comprises means for detecting a change in at least one property of the gas-sensing filament upon contact with the fluoro species and responsively generating an output signal indicative of the presence of such fluoro species.

A still further aspect of the invention relates to a method of monitoring a fluid locus for the presence of a target gas species therein, said method comprising:

exposing fluid at said fluid locus to a gas-sensing assembly as described hereinabove;

monitoring at least one property of the gas-sensing filament of such gas-sensing assembly; and

responsively generating an output signal when the gas-sensing filament exhibits a change in the at least one property thereof, indicating the presence of the target gas species in the fluid locus, or a change in concentration of the target gas species in the fluid locus.

As used herein, the term “fluoro species” is intended to be broadly construed to encompass all fluorine-containing materials, including without limitation, gaseous fluorine compounds, fluorine per se in atomic and diatomic (F₂) forms, fluorine ions, and fluorine-containing ionic species. The fluoro species may for example include species such as NF₃, SiF₄, C₂F₆, HF, F₂, COF₂, ClF₃, IF₃, etc., and activated fluorine-containing species (denoted collectively as F.) thereof, including ionized fragments, plasma forms, etc.

Other aspects, features and embodiments of the invention will be more fully apparent from the ensuing disclosure and appended claims.

### BRIEF DESCRIPTION OF THE DRAWINGS

FIG. 1 illustratively depicts the cross-sectional view of a gas-sensing filament comprising a Monel coating structure encapsulating a silicon carbide core structure, according to one embodiment of the present invention.

FIG. 2 shows a partial cross-section view of a composite core structure, according to one embodiment of the present invention.

FIG. 3 shows the output signals produced over time by a gas sensor assembly that employs a nickel-coated silicon carbide filament, in comparison with the output signals produced over time by a residual gas analyzer (RGA) unit.

FIG. 4 shows the output signals produced over time by a gas sensor assembly that employs a nickel filament, in comparison with the output signals produced over time by a residual gas analyzer (RGA) unit.

FIG. 5 shows a perspective view of a nickel filament comprising a neck portion that is electrochemically thinned, according to one embodiment of the present invention.

FIG. 6. illustratively depicts the cross-sectional view of a gas-sensing filament comprising a porous nickel coating, according to one embodiment of the present invention.

FIG. 7 is a SEM micrograph of a gas-sensing filament comprising a porous nickel coating formed on a dense substrate, according to one embodiment of the present invention.

FIG. 8. is a SEM micrograph of a gas-sensing filament comprising a porous nickel coating characterized by an open pore structure, according to one embodiment of the present invention.

FIGS. 9A and 9B show a gas-sensing assembly comprising two nickel-coated silicon carbide filament suspended by press fit electrical pins over a KF flange.

### DETAILED DESCRIPTION OF THE INVENTION, AND PREFERRED EMBODIMENTS THEREOF

The contents of U.S. patent application Ser. No. 10/273,036 filed Oct. 17, 2002 for “APPARATUS AND PROCESS FOR SENSING FLUORO SPECIES 1N SEMICONDUCTOR PROCESSING SYSTEMS” and U.S. Pat. No. 6,265,222 issued Jul. 24, 2001 for “MICRO-MACHINED THIN FILM HYDROGEN GAS SENSOR, AND METHOD OF MAKING AND USING THE SAME” are incorporated herein by reference in their entirety for all purposes.

While the invention is described more fully hereinafter with specific reference to applications in semiconductor process control, it is to be appreciated that the utility of the invention is not thus limited, but rather extends to a wide variety of other uses and applications, including, without limitation, deployment in life safety systems, room or ambient environment monitoring operations, and other industrial as well as consumer market gas-sensing applications.

As is well known, fluoro species react with most metals to form compounds that have a high, and sometimes, mixed oxidation state (Inorganic Solid Fluorides, Chemistry and Physics. Academic Press, 1985, Ed P. Hagenmuller). Many of the transition metals and noble metals (including, for example, but not limited to Ni, Cu, Al, Ti, V, Cr, Mn, Nb, Mo, Ru, Pd, Ag, Ir, and Pt) readily form various non-volatile fluorinated compounds in contact with such fluoro species.

The present invention therefore employs fluoro-reactive metal filaments. By monitoring changes in the properties of such metal filaments as caused by their reaction with fluoro species, one can determine the presence and/or concentration of one or more target fluoro species in a particular gaseous environment, such as a effluent gas stream discharged by a semiconductor chamber clean process.

Specifically, the electrical resistance increase observed for a fluoro-reactive metal filament, when placed in a gaseous environment susceptible to contamination by a fluoro species, has been found to be a good indicator of the presence and concentration of such fluoro species in the environment. Because the metal filament possesses higher thermal conductivity than the gaseous environment, a significant portion of the heat generated by the exothermic reactions between the metal filament and the fluoro species is channeled to the metal filament, causing temperature increase in such metal filament, which in turn raises the electrical resistance of such metal filament.

Specifically, the present invention relates to the uses of nickel-containing filaments, which contains either pure nickel or nickel alloys, in gas-sensing assembly for detection of target fluoro species.

One preferred embodiment of the invention employs a gas-sensing filament comprising a fluoro-reactive coating structure that contains nickel or nickel alloy, while such coating structure encapsulates a high resistivity, low thermal mass core structure, which is characterized by an electrical resistivity that is higher than that of the coating structure and a heat capacity (i.e., the product of specific heat Cₚ and density D) that is lower than that of the coating structure.

Preferably, such core structure is characterized by an electrical resistivity that is at least fifty (50) times larger than that of the coating structure, and a heat capacity that is less than three fourth (¾) of that of the coating structure. More preferably, such core structure is characterized by an electrical resistivity that is at least one thousand (1000) times larger than that of the coating structure, and a heat capacity that is less than one half (½) of that of the coating structure. Most preferably, such core structure is characterized by an electrical resistivity that is at least 10 mΩ·cm and a heat capacity that is less than 2.5 J/K·cm³.

Many combinations of materials are available for forming such coating and core structures. Without limiting the broad scope of the present invention, examples of materials suitable for forming the coating and core structures are herein provided, which include: (1) pure nickel for the coating and a nickel alloy (such as Monel, a nickel-copper alloy) for the core; (2) pure nickel or nickel alloy for the coating and silicon carbide for the core; (3) pure nickel or nickel alloy for the coating and carbon for the core, etc.

Silicon carbide is particularly preferred for forming the core structure in the present invention, because the high electrical resistivity (usually greater than 10 mΩ cm) and low heat capacity (usually less than 2.5 J/K·cm³) of silicon carbide further enhances the signal strength and responsiveness of the nickel-containing filament sensor, without inducing significant heat loss. Moreover, silicon carbide is resistant to attack by the corrosive fluorine plasma, which, although is not a necessary feature of the encapsulated core structure, advantageously improves the mechanical robustness and reliability of the filament sensor when used in corrosive gaseous environment for detecting fluoro species.

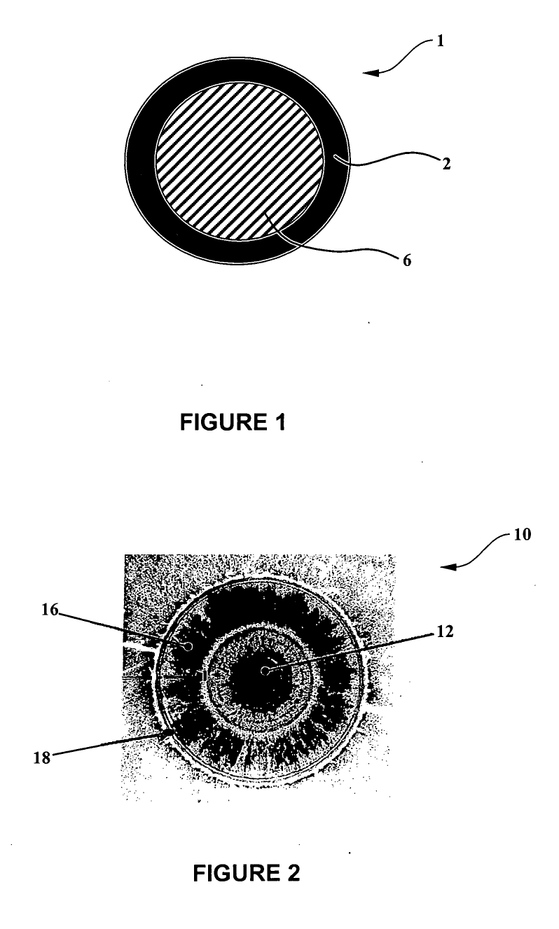

FIG. 1 illustratively shows the cross-sectional view of a gas-sensing filament 1 according to one embodiment of the invention, which comprises a core structure 6 made of β-silicon carbide encapsulated by a coating 2 fabricated by using the nickel-copper alloy, Monel.

Composite structures comprising multiple layers of high resistivity, low thermal mass materials can also be used to form the core structure for the filament sensors of the present invention. Various combinations and configurations of suitable core materials can be employed to further improve the performance of the filament sensors. In one instance of the present invention, silicon carbide fibers can be used, upon which a thin layer of nickel is formed as the gas-sensing layer.

FIG. 2 shows a partial cross-sectional view of a silicon carbide fiber 10. Such silicon carbide has an overall diameter of from about 78 microns to about 140 microns, which includes a carbon core 12 enclosed in a β-SiC sheath 16 with a carbon rich surface 18. The SCS silicon carbide fibers have a heat capacity (Cₚ times D) that is about one half of that of nickel, and are resistant to fluoro species.

For quantitatively determining the signal strength and responsiveness of gas-sensing assemblies that contain the nickel-containing filaments as described hereinabove, effluent gas containing fluoro species from a semiconductor cleaning chamber is first contacted with such gas-sensing assemblies that contain nickel-containing filaments, to generate a set of sensor signal outputs. Such effluent gas is then passed through a residual gas analyzer (RGA) unit, to generate a set of control outputs. The graphical outputs produced by the gas-sensing assemblies of the invention and the control outputs produced by the RGA unit can be superposed as a function of time, to visualize the relative signal strength and responsiveness of such gas-sensing assemblies of the invention.

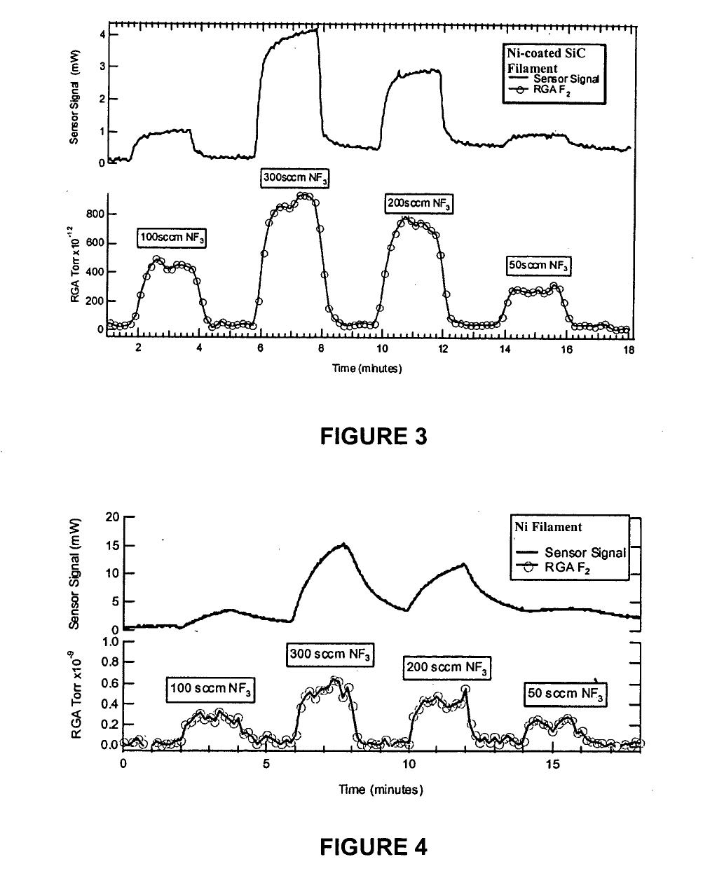

FIG. 3 shows in the upper portion thereof, the signal outputs generated over time by a gas-sensing assembly comprising a nickel-coated SiC fluoro-sensitive filament, and the control outputs produced over time by a RGA unit are shown in the lower portion of FIG. 3.

FIG. 4, on the other hand, shows the signal outputs over time from a gas-sensing assembly that employs a nickel filament, in comparison with the control outputs produced over time by a RGA unit. Both gas-sensing assemblies demonstrate high sensitivity and high responsiveness, although the gas-sensing assembly containing the nickel-coated SiC filament shows better sensitivity and shorter response time than the one employing nickel filament.

To further enhance the performance of the nickel-containing filament sensors of the present invention, a high Aₛ/A_{c} ratio is desired, according to equation (19) provided hereinabove.

High Aₛ/A_{c} ratio can be effectively achieved by configuring the nickel-containing filaments at average outer diameters of less than 500 microns, more preferably less than 150 microns or less than 50 microns, and most preferably in a range of from about 0.1 micron to about 30 microns, and average lengths of more than 1 cm, more preferably more than 5 cm, and most preferably more than 10 cm, as a balance between performance and ease of fabrication.

However, filaments having a diameter of about or less than 50 microns are extremely fragile and difficult to handle, rendering the fabrication of a gas-sensing assembly with such small filaments nearly impossible.

The present invention provides a solution to such problem, by first fabricating a gas-sensing assembly using a nickel-containing gas-sensing filament that has an average diameter larger than 50 microns, and then electrochemically thinning such gas-sensing filament to reduce its average diameter to increase the Aₛ/A_{c} ratio. In this event, the thinning process is carried out on a gas-sensing filament that has already been incorporated into the gas-sensing assembly, and no further handling of the gas-sensing filament is necessary after thinning, therefore significantly reducing the risk of damaging the ultra-thin filament.

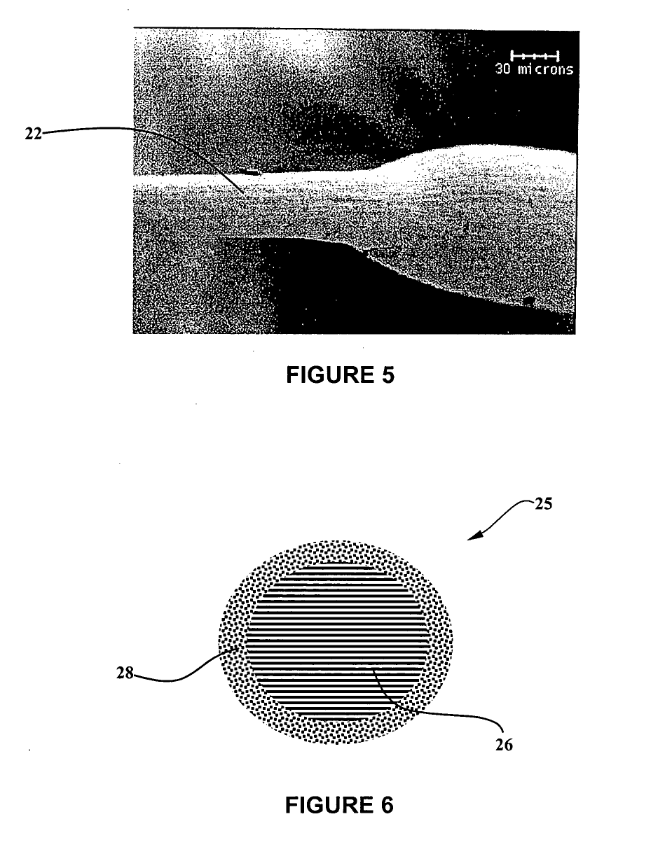

FIG. 5 shows a partially thinned nickel filament 22, which has an original average diameter of about 100-110 microns. After electrochemical thinning at a portion of such filament 22, the average diameter is effectively reduced to about 35-45 microns.

High Aₛ/A_{c} ratio can also be achieved by forming a nickel-containing filament having a porous surface, which functions to increase the surface area Aₛ of the filament sensor without comprising the cross-sectional area A_{c} thereof.

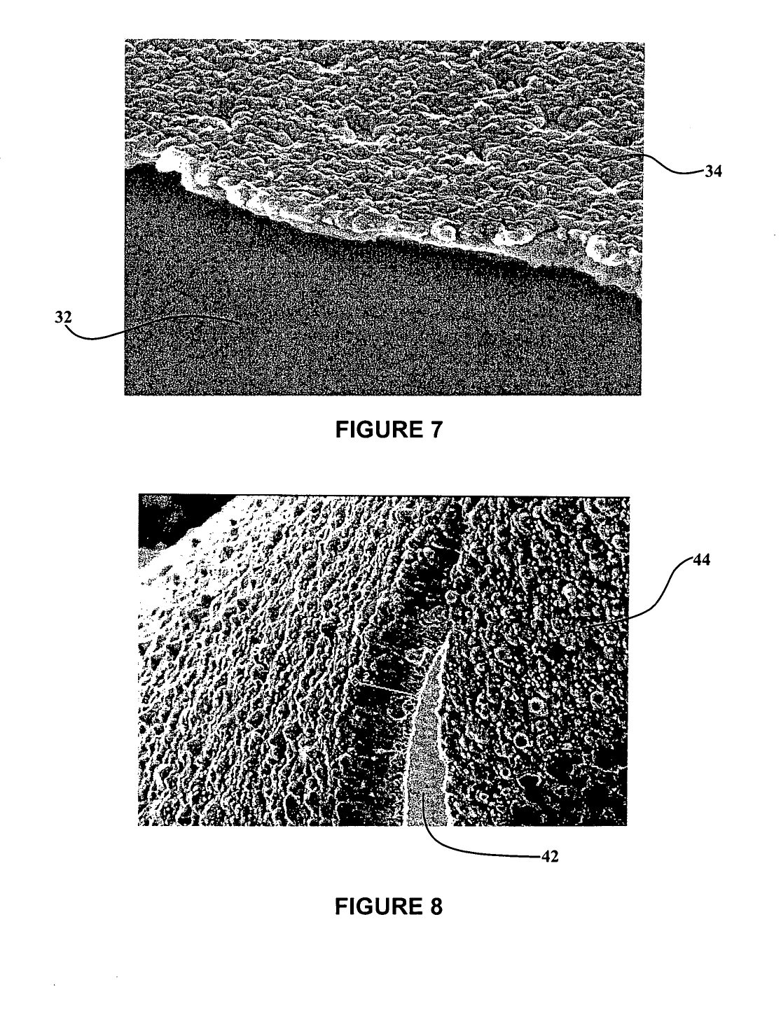

FIG. 6 illustratively shows a nickel-containing filament 25 that comprises a relatively dense core 26 and a porous surface 28. The porous surface of the nickel-containing filament may be provided by a two-stage plating process, wherein at an initial seeding stage, the plating of nickel or nickel alloy on a substrate (such as a core structure) is carried out at a relatively low speed, so as to allow improved bonding between the layer of nickel or nickel alloy plated and the underlying substrate, and wherein at the subsequent growth stage, the plating is conducted at a significantly faster rate, so as to form rough plating surface with microporosity or nanoporosity. FIG. 7 shows a SEM micrograph of a nickel coating 34 of nanoporosity formed on a non-porous, dense substrate 32.

Alternatively, porous nickel coating can be formed by using liquid crystal templates from proper surfactants. This technique is particularly suitable for forming open pore structures, which maximizes the fluoro-accessible surface area of the porous nickel coating and therefore further improves the sensitivity of the filament sensor. FIG. 8 shows a SEM micrograph of a porous nickel coating 44 characterized by open pore structures and having a thickness of about 4.93 microns, formed on a dense silicon carbide substrate 42. The porous nickel coating may be characterized by, for example, a total porosity of 60%, as determined by X-ray fluorescence analysis.

The performance of the nickel-containing gas-sensing filaments of the present invention can be further enhanced, by using various nickel-copper alloys, such as Monel, which are characterized by electrical resistance that are even higher than the pure nickel.

Preferably, such nickel-copper alloy contains from about 10% to 90% nickel from about 10% to about 90% copper by weight. Such nickel-copper alloy may further comprise other fluorine-resistant metals such as Al, Ti, V, Cr, Mn, Nb, Mo, Ru, Pd, Ag, Ir, and Pt.

The above-described various embodiments of the invention can be either independently implemented, or jointly employed, to provide a group of gas-sensing filaments with diverse material and structural characteristics that suit the requirements of various systems and applications. It will be recognized that the choice of a specific material and configuration for the fluoro species sensing element of the invention may vary according to the character of the stream being monitored for the presence of fluoro species, and particularly according to the concentration of the target gas species being monitored or otherwise present in the monitored gas.

The present invention thus provides a group of novel solid-state filament gas sensors that can be coupled in sensing relationship to a process chamber, e.g., a semiconductor process chamber, and can achieve various degrees of sensitivity and responsiveness, by appropriate selection of materials and structures for such filament sensors.

The fluoro sensor assembly of the invention may include a single filament sensor element in any of the numerous suitable forms described hereinabove.

Alternatively, the fluoro sensor assembly may comprise a plurality of such sensor elements, wherein the multiple elements provide redundancy or back-up sensing capability, or in which different ones of the multiple sensor elements are arranged for sensing of different fluoro species in the stream or gas volume being monitored, or in which different ones of the sensor elements in the array are operated in different modes, or in interrelated modes, such as for production of respective signals that are algorithmically manipulated, e.g., subtractively, to generate a net indicating signal, or alternatively, additively to produce a composite indicating signal, or in any other suitable manner in which the multiplicity of sensor elements is efficaciously employed to monitor the flow of species in the stream or fluid volume of interest, for generation of correlative signal(s) for monitoring or control purposes.

The metal filament sensor of the present invention can be operated under different modes, in order to achieve active sensing of a target fluoro species, which include but are not limited to, a constant current (CC) mode and a constant resistance (CR) mode. At the constant current (CC) mode, the electrical current passing through the metal filament is maintained constant as a control, while the electrical resistance of such metal filament fluctuates and is treated as the signal. Alternatively, at the constant resistance (CR) mode, the electrical resistance of the metal filament is maintained constant and treated as a control, while the electrical current passing therethrough is allowed to fluctuate and treated as the signal.

The gas-sensing filaments of the invention can be readily mounted in any manner to form the gas-sensing assembly, which may also comprise means for detecting changes in such gas-sensing filament upon contact thereof with a target fluoro species, and means for responsively generating an output signal indicative of such changes. For example, such gas-sensing filament may be mounted in various free-standing manners to a fluoro-resistant support structure, as disclosed by U.S. patent application Ser. No. 10/273,036 filed Oct. 17, 2002 for “APPARATUS AND PROCESS FOR SENSING FLUORO SPECIES IN SEMICONDUCTOR PROCESSING SYSTEMS,” the contents of which are incorporated herein by reference in their entirety.

The free-standing gas-sensing filaments can be integrated as part of a device package in any suitable manner, and additional protection or insulation layers may be applied to such device package, for enhancing the resistance of the overall device package to corrosions by the fluorine-containing target compounds.

The ability to integrate the free-standing gas-sensing filaments into a standard microelectronic device package such as a chip carrier package, enables the gas sensor apparatus of the invention to be variously configured as a single-element device structure, or alternatively as a multi-element array, e.g., using varied metal structures, different geometries, or redundant structures operating at different temperatures, to enhance the gas detection capability of the overall sensing device.

In instances where multiple sensor elements are provided, different ones of the multiple sensor elements may be constructed and arranged for sensing of different fluorinated species in the fluid environment being monitored, and/or same fluorinated species at different temperatures, and different geometries and configurations of sensor elements may be employed for redundancy and/or ensuring accuracy, etc. Alternatively, or additionally, different ones of the multiple sensor elements may be operated in different operating modes, e.g., resistively, conductively, pulsed, a DC mode, an AC mode, etc.

In connection with the use of arrays of gas-sensing elements, advanced data processing techniques can be used to enhance the output of the sensor system. Examples of such techniques include, but are not limited to, the use of compensating signals, the use of time-varying signals, heater currents, lock-in amplifying techniques, signal averaging, signal time derivatives, and impedance spectroscopy techniques. In addition, advanced techniques that fall into the category of chemometrics may also be applied. These techniques include least squares fitting, inverse least squares, principal component regression, and partial least square data analysis methods.

The gas-sensing element(s) of the invention may therefore be coupled in a suitable manner, within the skill of the art, to transducers, computational modules, or other signal processing units, to provide an output indicative of the present or change in amount of one or more fluoro species in the fluid environment being monitored.

In a preferred embodiment, the gas-sensing filament of the present invention is supported on a fluoro-resistant flange material, e.g., a KF flange formed of Vespel® polyimide, aluminum, or nickel. Vespel® polyimide is a preferred polyimide material of construction in various embodiments of the invention, but it will be recognized that other polyimide or polymeric (e.g., polysulfone) materials of construction may alternatively be used.

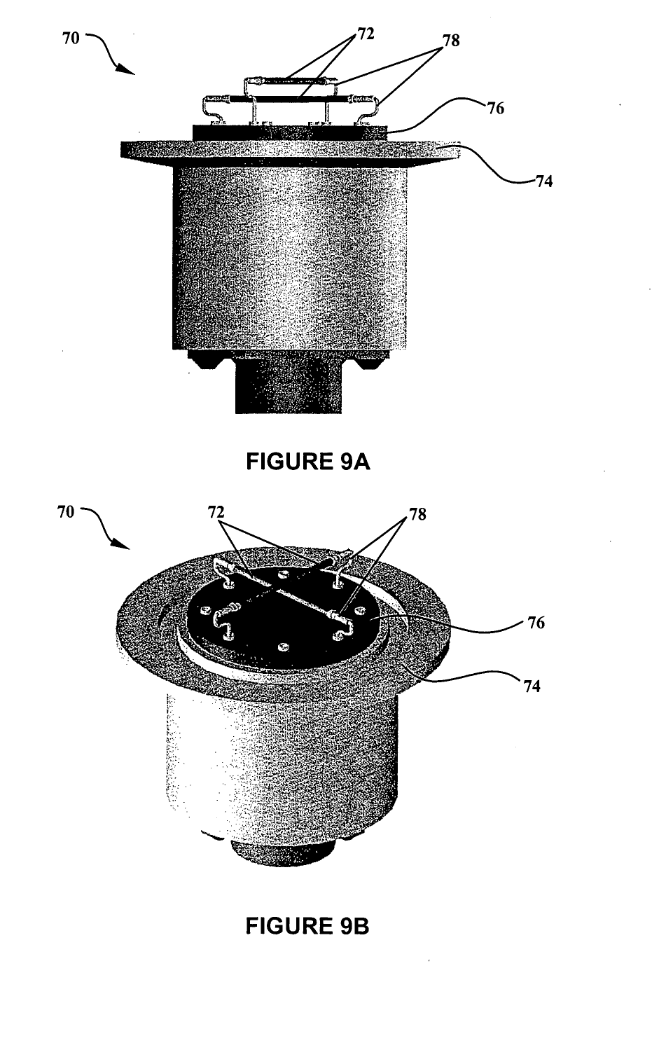

FIGS. 9A and 9B depict a gas sensor array 70 including a Vespel® polyimide flange 74 supporting a Vespel® polyimide block 76, and two sets of nickel-coated press-fit electrical pins 78 thereon, for suspending two nickel-coated SiC gas-sensing filaments 72, which may or may not be the same in structure.

The free-standing architecture of the nickel-coated SiC filaments allow them to be used both as the fluoro-sensing elements and the heat sources (e.g., susceptible to electrical resistance heating or other mode of heating), as well as maximizing the sensing area, as a result of the high surface-to-volume character of such filaments. The integrated design of the gas-sensing filaments and associated packaging obviates the problem of chemical attack by aggressive fluorinated gas species in the sensing environment, thereby achieving a fundamental advance in the art over standard silicon MEMS structures.

It will be recognized that micro-hotplate structures of a type adaptable to the practice of the present invention may be employed in the gas sensor assemblies of the present invention, as more fully described in U.S. Pat. No. 6,265,222 issued Jul. 24, 2001 in the names of Frank DiMeo, Jr. and Gautam Bahndari, the disclosure of which hereby is incorporated herein by reference in its entirety.

Although the invention has been variously described herein with reference to illustrative embodiments and features, it will be appreciated that the embodiments and features described hereinabove are not intended to limit the invention, and that other variations, modifications and other embodiments will readily suggest themselves to those of ordinary skill in the art, based on the disclosure herein. The invention therefore is to be broadly construed, consistent with the claims hereafter set forth.

What is claimed is:

1. A gas sensor assembly comprising a gas-sensing filament comprising nickel or nickel alloy, and means for detecting a change in at least one property of said gas-sensing filament upon contact with a target gas species and responsively generating an output signal indicative of presence of said target gas species.

2. The gas sensor assembly of claim 1, wherein the target gas species comprises a fluoro species selected from the group consisting of NF₃, SiF₄, C₂F₆, HF, F₂, COF₂, ClF₃, IF₃, and activated species thereof.

3. The gas sensor assembly of claim 1, wherein said gas-sensing filament is characterized by an average diameter of less than about 500 microns.

4. The gas sensor assembly of claim 1, wherein said gas-sensing filament is characterized by an average diameter of less than about 150 microns.

5. The gas sensor assembly of claim 1, wherein said gas-sensing filament is characterized by an average diameter of less than about 50 microns.

6. The gas sensor assembly of claim 1, wherein said gas-sensing filament is characterized by an average diameter in a range of from about 0.1 micron to about 30 microns.

7. The gas sensor assembly of claim 1, wherein said gas-sensing filament is characterized by a length of more than about 1 cm.

8. The gas sensor assembly of claim 1, wherein said gas-sensing filament is characterized by a length of more than about 5 cm.

9. The gas sensor assembly of claim 1, wherein said gas-sensing filament is characterized by a length of more than 10 cm.

10. The gas sensor assembly of claim 1, wherein said gas-sensing filament comprises a coating structure encapsulating a core structure, wherein said coating structure comprises nickel or nickel alloy, and wherein said core structure has an electrical resistivity that is higher than that of the coating structure and a heat capacity that is lower than that of the coating structure.

11. The gas sensor assembly of claim 10, wherein the electrical resistivity of the core structure is at least about fifty times higher than that of the coating structure, and wherein the heat capacity of said core structure is less than three fourth of that of the coating structure.

12. The gas sensor assembly of claim 10, wherein the electrical resistivity of the core structure is at least about a thousand times higher than that of the coating structure, and wherein the heat capacity of said core structure is less than one half of that of the coating structure.

13. The gas sensor assembly of claim 10, wherein the electrical resistivity of the core structure is at least about 10 m∩·cm, and wherein the heat capacity of said core structure is less than 2.5 J/K·cm³.

14. The gas sensor assembly of claim 10, wherein said core structure comprises a nickel-copper alloy, and wherein said coating structure consists essentially of nickel.

15. The gas sensor assembly of claim 10, wherein said core structure comprises silicon carbide.

16. The gas sensor assembly of claim 10, wherein said core structure comprises a composite fiber having multiple layers of different materials.

17. The gas sensor assembly of claim 10, wherein said core structure comprises a composite fiber having a carbon core fiber coated with a silicon carbide layer.

18. The gas sensor assembly of claim 1, wherein the gas-sensing filament is electrochemically thinned after fabrication of said gas sensor assembly and is characterized by an average diameter of not more than 50 microns.

19. The gas sensor assembly of claim 18, wherein the gas-sensing filament is characterized by an average diameter of not more than 25 microns.

20. The gas sensor assembly of claim 18, wherein the gas-sensing filament is characterized by an average diameter of not more than 10 microns.

21. The gas sensor assembly of claim 18, wherein the gas-sensing filament is characterized by an average diameter in a range of from about 0.1 micron to about 5 microns.

22. The gas sensor assembly of claim 1, wherein the gas-sensing filament comprises a nickel-copper alloy containing from about 10% to about 90% nickel and from about 10% to about 90% copper by total weight of said alloy.

23. The gas sensor assembly of claim 22, wherein said nickel-copper alloy further comprises from about 10% to about 90% aluminum by total weight of said alloy.

24. The gas sensor assembly of claim 23, wherein said nickel-copper alloy further comprises one or more metals selected from the group consisting of Ti, V, Cr, Mn, Nb, Mo, Ru, Pd, Ag, Ir, and Pt.

25. The gas sensor assembly of claim 1, wherein said gas-sensing filament comprises a porous coating of nickel or nickel alloy.

26. The gas sensor assembly of claim 25, wherein said porous coating is characterized by open pore structures.

27. The gas sensor assembly of claim 1, further comprising a support structure for suspending said gas-sensing filament.

28. The gas sensor assembly of claim 27, wherein said support structure comprises a material that is resistant to said target gas species.

29. The gas sensor assembly of claim 27, wherein the target gas species comprises a fluoro species selected from the group consisting of NF₃, SiF₄, C₂F₆, HF, F₂, COF₂, ClF₃, IF₃, and activated species thereof, and wherein the support structure comprises a material selected from the group consisting of polyimide, aluminum, or nickel.

30. A method for monitoring a fluid locus for the presence of a target gas species therein, said method comprising:
exposing fluid at said fluid locus to a gas-sensing assembly as in claim 1;
monitoring at least one property of the gas-sensing filament of such gas-sensing assembly; and
responsively generating an output signal when the gas-sensing filament exhibits a change in the at least one property thereof, indicating the presence of the target gas species in the fluid locus, or a change in concentration of the target gas species in the fluid locus.

31. The method of claim 30, wherein said at least one property of the gas-sensing filament being monitored is the electrical resistance thereof.

32. A gas sensor assembly comprising a gas-sensing filament comprising a coating structure encapsulating a core structure, wherein said coating structure comprises a gas-sensitive material that exhibit a detectable change upon contact with a target gas species, and wherein said core structure is characterized by an electrical resistivity that is higher than that of the coating structure and a heat capacity that is lower than that of the coating structure.

33. A gas sensor assembly comprising a gas-sensing filament comprising a coating structure and a core structure, wherein said coating structure comprises nickel or nickel alloy, and wherein said core structure comprises silicon carbide.

34. A gas sensor assembly comprising a gas-sensing filament comprising a coating structure and a core structure, wherein said coating structure comprises nickel or nickel alloy, and wherein said core structure comprises a carbon center and a sheath of silicon carbide.

35. A gas sensor assembly comprising an electrochemically-thinned gas-sensing filament comprising nickel or nickel filament, wherein said filament is characterized by an average diameter of not more than 50 microns.

36. A method for forming the gas sensor assembly of claim 35, comprising the steps of:
(a) providing a gas sensor assembly precursor comprising a gas-sensing filament comprising nickel or nickel filament, wherein said filament has an average diameter of more than 50 microns;
(b) electrochemically thinning said gas-sensing filament for a sufficient period of time, so as to reduce the average diameter thereof to not more than 50 microns.

37. A method for forming a gas sensor assembly, comprising the steps of:
(a) providing a gas sensor assembly precursor comprising a gas-sensing filament comprising nickel or nickel filament;
(b) electrochemically thinning said gas-sensing filament for a sufficient period of time, so as to reduce the average diameter thereof.

38. A gas sensor assembly comprising a gas-sensing filament comprising a nickel-copper alloy.

39. A gas sensor assembly comprising a gas-sensing filament comprising a nickel-copper-aluminum alloy.

40. The gas sensor assembly of claim 39, wherein said nickel-copper-aluminum alloy comprises from about 10% to about 90% of nickel, from about 10% to about 90% of copper, and from about 10% to about 90% of aluminum, by total weight of said alloy.

41. A gas sensor assembly comprising a nickel-containing gas-sensing filament having a porous surface.

42. The gas sensor assembly of claim 41, wherein said porous surface is characterized by open pore structures.

43. A gas sensor assembly comprising a support structure for suspending a free-standing nickel-containing gas-sensing filament.

44. The gas sensor assembly of claim 43, wherein said support structure comprises a material that is resistant to fluoro species.

45. The gas sensor assembly of claim 43, wherein said support structure comprises a material selected from the group consisting of polyimide, aluminum, and nickel.

46. A gas sensor assembly arranged in sensing relationship to a process chamber that is susceptible to presence of one or more target fluoro species, wherein said gas sensor assembly comprises a gas-sensing filament containing nickel or nickel-alloy, as mounted on a fluoro-resistant support structure and coupled to means for detecting a change in at least one property of said gas-sensing filament upon contact with the target fluoro species and responsively generating an output signal indicative of the presence of said target fluoro species.
